(19) United States
(12) Patent Application Publication
(10) Pub. No.: US 2006/0277824 A1
(43) Pub. Date: Dec. 14, 2006

(54) Decorative hanging plant support

(76) Inventor: Sharon A. Clair, Amherst, NH (US)

Correspondence Address: JOSEPH E. FUNK, 82 CHASE RD, LONDONDERRY, NH, 03053, US

(21) Appl. No.: 11/148,832

(22) Filed: Jun. 9, 2005

(51) Int. Cl. A01G 9/02

(52) U.S. Cl. 47/67; 248/318

(57) ABSTRACT

A decorative plant hanger is disclosed having ropes that support a pot in which plants are planted. To provide a decorative appearance the ropes are covered with cloth or plastic tubes that are colored and/or otherwise decorated. The decorated tubes permit a plant hanger manufacturer to offer a generic plant hanger and a selection of decorated tubes which a customer may select to meet their individual taste at the time of purchase or to be replaced at a later time. A cover that may have the same decoration as the decorated tubes is provided to cover knots or loops in the ropes at the top of the hanger. A spacer is provided to keep the ropes properly spaced around the pot.

### RELATED APPLICATION

This application is related to co-pending U.S. Provisional Patent Application No. 06/102,004, entitled “Decorative Hanging Plant Support”, filed on Jun. 10, 2004.

### FIELD OF THE INVENTION

The invention relates to plant hangers and more particularly to a decorative hanger for suspending a plant container from an overhead support.

### BACKGROUND OF THE INVENTION

Plant hangers having elongated members in the form of ropes for suspending a plant in a pot from an overhead support are in wide use. However, the ropes generally have a bland appearance that does not contribute to the decorative nature of either the plant or the hanger. To overcome this lack of decoration plant hanger ropes are dyed different colors and/or have a variety of knots tied in them in an attempt to contribute to the decorative nature of the plant hanger. This attempt to provide a decorative plant hanger is very limited because while it permits the manufacturer to change the colors and knots during manufacture the average user of a plant hanger cannot change the color of the ropes and cannot easily change the type or arrangement of the knots tied in the ropes. Replacement plant hanger ropes are not available on the market because they would cost nearly as much as the original plant hanger. The cost of making plant hanger ropes with different types and arrangements of knots therein is the most costly part of manufacture of a plant hanger. Thus, there is a need in the prior art for a way to more easily change the decorative nature of plant hangers.

### SUMMARY OF THAT INVENTION

In accordance with the teaching of the present invention a means is taught that quickly and easily permits changing the appearance of the elongated rope members of a plant hanger. A manufacturer may less expensively and more easily change the appearance of plant hanger ropes during manufacture to change the appearance of their plant hanger products to meet seasonal changes and to meet changes in styles demanded by their customers. In addition, the user of such a plant hanger may at any time change the decorative appearance of the ropes of the plant hanger to match the color scheme of the plants, the pot, or the locale in which the plant hanger is utilized.

More particularly, the invention comprises cloth or plastic tubes that are slid over the ropes of a plant hanger. The tubes may be colored and may have decorative patterns printed thereon. The colors and decorative patterns are picked to match customer demands, the colors of plants, pots and the locale in which the plant hanger is used to provide a decorative appearance. In addition, the cloth tubes may be changed at any time to alter the decorative appearance. This latter advantage is of particular interest to users of the plant hangers who wish to customize the appearance of their plant hangers at the time of purchase, and to alter the appearance of the plant hangers at a later time. To provide these features plant hanger manufacturers may offer a generic plant hanger and at the time of purchase a user will select decorative tubes that meet their individual desires. The user will then install the decorative tubes that they have selected on the ropes of the plant hanger prior to use. At a later time a user may change the decorative tubes according to their tastes to change the decor.

### DESCRIPTION OF THE DRAWINGS

The invention will be better understood upon reading the following detailed description in conjunction with the drawing in which:

FIG. 1 shows the undecorated backside of a strip of fabric material used to make a decorative cloth tube;

FIG. 2 shows the strip of fabric material sewn into a fabric tube with the undecorated backside to the exterior of the tube;

FIG. 3 shows the sewn fabric tube turned inside out to show the decorative pattern on one side of the fabric material on outside of the fabric tube;

FIG. 4 shows one end of the fabric tube of FIG. 3 with a rope passing there through;

FIG. 5 shows a plant hanger made from a plurality of ropes each having a decorative fabric tube over the rope;

FIG. 6 shows the top of the plant hanger with a decorative wrap covering knots or other joining means thereat;

FIG. 7 shows the bottom of a plant hanger supporting a pot therein;

FIG. 8 shows a spacer element that is utilized to keep ropes of the plant hanger properly spaced around a pot in the plant hanger; and

FIG. 9 shows the spacer element assembled with a plant hanger and keeping ropes of the hanger equally spaced around a pot positioned in the hanger.

### DETAILED DESCRIPTION

The need in the prior art for a way to change the decorative appearance of ropes of plant hangers is met by the present invention. Decorative tubing is placed over the ropes of a hanging planter that is used to suspend a pot with a plant therein from an overhead support surface. The tubing may have any combination of background colors and decorative patterns thereon and is quickly and easily changeable to change the decorative appearance of the ropes used with the plant hanger to match the color scheme of the plants, the pot, or the locale in which the plant hanger is utilized. The tubing may be made from cloth or plastic. In the remainder of the description only a fabric tube is mentioned.

A manufacturer may less expensively and more easily change the appearance of the plant hanger ropes during manufacture to change the appearance of their plant hanger products to meet seasonal changes and to meet changes in styles demanded by their customers. The manufacturer may also offer a generic plant hanger and at the time of purchase a customer will select a set of decorative tubes that meet their individual tastes. The customer will then install the decorative tubes that they have selected on the ropes of the plant hanger prior to use. In addition, at a later time a customer may separately purchase decorative cloth tubes to alter the appearance of their plant hangers.

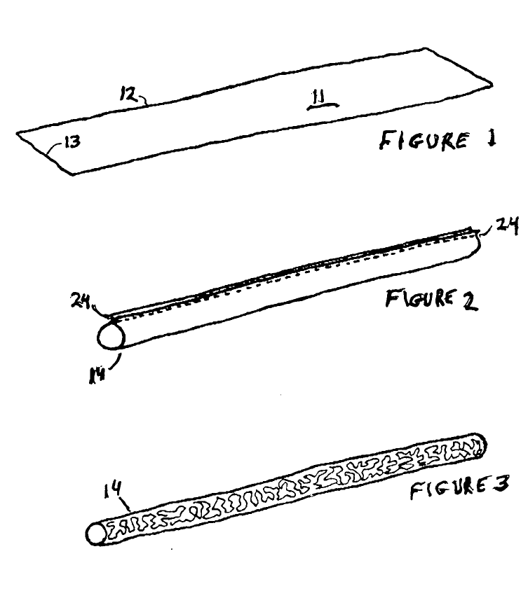

In FIG. 1 is shown the undecorated backside of a decorative strip 11 of fabric material that has a width 13 of two inches wide and a length 12 of three to four feet or more. The front side, not seen in Figure, is colored and has other decorations thereon. The fabric strip 11 is folded lengthwise and its two long edges 12 are stitched together along 24 as shown in FIG. 2 to form an inside out fabric tube 14.

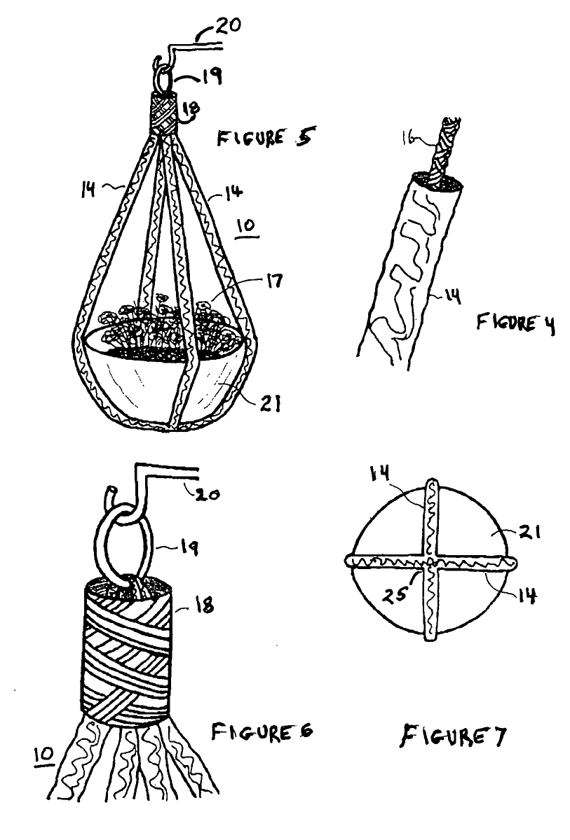

The fabric tube 14 is then turned inside out lengthwise so that the decorative colors and pattern on the front side of fabric tube 14 are seen, such as shown in FIG. 3. Tube 14 is made in this manner so that the stitching and unfinished longer edges 12 are not seen in the final product. Each piece of rope of a plant hanger is then inserted through a piece of fabric tube 15 as shown in FIG. 4. The diameter of fabric tube 14 is two or more times the diameter of rope 16 so that rope 16 can pass easily through tube 14. In addition, fabric tube 14 may be left in an un-stretched state so that it has a loose, somewhat crumpled appearance that enhances its decorative appearance.

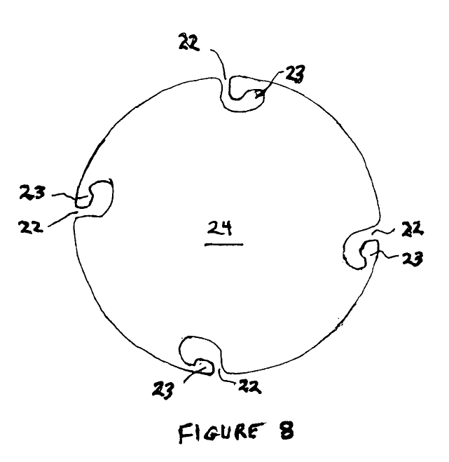

In FIG. 5 is shown a completed plant hanger 10 made from a plurality of ropes 16, each having a decorative fabric tube 14 over the rope, and a pot 21 with flowers 17 therein held within the decorated ropes 16. In a matter well known in the art the decorated ropes are fastened together, often by tying, above pot 21 as shown. The ends of decorated ropes 16 may be tied or otherwise fastened to a metal ring 19 as shown. Ring 19 is then hung from an overhead support 20.

Alternatively, all the ends of the decorated ropes 16 may be tied to have a loop formed thereon and all the loops may be hooked onto one side of an S-hook. The other side of the S-hook would then be hung from an overhead support hook 20.

In FIG. 6 is shown the plant hanger 10 with decorative fabric tubing 14 covering all of ropes 16 and with a decorative wrap 18 covering the unsightly knots or loops (not shown) at the top of hanger 10. Wrap 18 may preferably have mating Velcro pieces (not shown) on opposing edges to facilitate quickly and easily placing the wrap over the knots or loops. Alternatively, wrap 18 may utilize snaps or other fastening means for placing the wrap over the knots or loops.

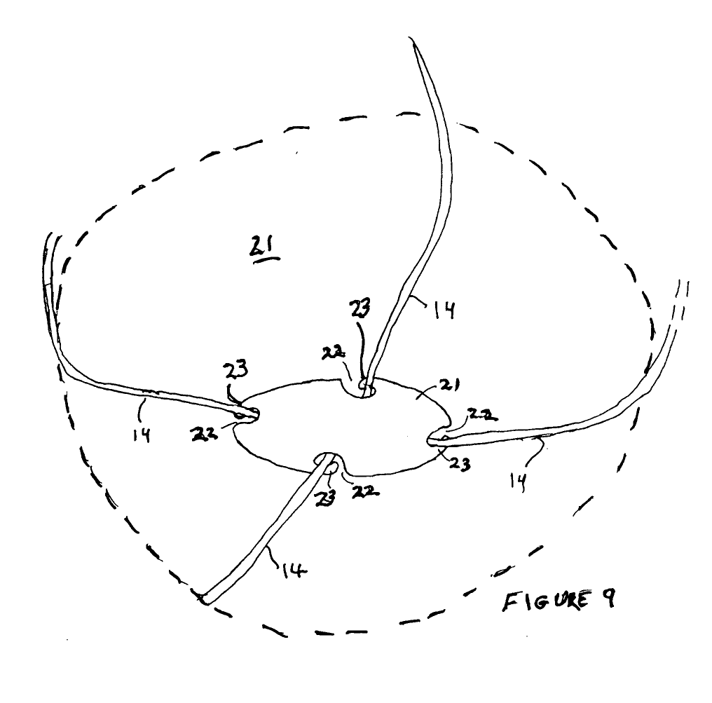

FIG. 7 shows the bottom of a plant hanger 10 supporting a pot 21 in the plant hanger. Two ropes 16 with decorative wrap 14 thereon are passed under the bottom of pot 21 as shown in FIG. 7 to prevent pot 21 from falling out of the plant hanger. In an alternative embodiment of the invention the ropes 16 with decorative covers 14 do not loop underneath pot 21, but rather one end of the rope connects to hanger loop 19 and the other end of the rope attaches to pot 21 (not shown) or to a tray or other receptacle (not shown) in which pot 21 sits.

To facilitate having ropes 16 with decorative wrap 14 thereon being in the proper position under pot 21 as shown a FIG. 7, a circular plastic piece 24 is provided such as shown in FIG. 8. Piece 24 is a rope spacer that inhibits pot 21 from falling out of plant hanger 10. Piece 24 is preferably round with four, or more, equally spaced cutouts 22 that create tabs 23 as shown.

In FIG. 9 is shown plastic piece 24 in use to keep ropes 16 with decorative wraps 14 thereon properly spaced around pot 21 so the pot 21 does not fall out of plant hanger 10. Between the bottom of pot 21 and the top of plastic piece 24 the tubing 14 covered ropes 16 cross over each other as shown in FIG. 7. Piece 24 is positioned over ropes 16 so that the ropes are held against the bottom of pot 21. Each of the ropes 16 is then positioned in a cutout 22 as shown. The tabs 23 partially cover each of the ropes 15 in such a manner that the ropes cannot easily move out of cutouts 22 and ropes 15 are thereby held in their properly spaced positions. Prefereably, ropes 16 may pass underneath plastic piece 24 and not be concealed by piece 24. Piece 24 is preferably colored to match the color of pot 21.

While what has been described above is the preferred embodiment of the invention it will be understood by those skilled of the art that numerous changes may be made without departing from the spirit and scope of the invention.

1. A plant support for hanging a container with a plant therein from a support surface, the plant support comprising:
a plurality of elongated members that support the container, the elongated members each having a first end, the first end of the plurality of elongated members being joined together and used to hang the plant support from the support surface; and
a first plurality of decorative covers, a cover being placed over each of the first plurality of elongated members before their first ends are joined to provide a decorative appearance to the hanging plant support, the decorative covers being replaceable to change the decorative appearance of the hanging plant support.

2. The hanging plant support of claim 1 further comprising a second plurality of decorative covers, wherein the first end of each of the plurality of elongated members may be unjoined from each other to remove the first plurality of decorative covers over the plurality of elongated members, wherein one of the second plurality of decorative covers is then placed over each of the plurality of elongated members to change the decorative appearance of the hanging plant support, and wherein the first end of all of the plurality of elongated members are then rejoined and the plant support hung from the support surface.

3. The hanging plant support of claim 2 further comprising a decorative element that is placed over the first end of all of the plurality of elongated members after they are joined together, the decorative element being removed to unjoin the first end of all of the plurality of elongated members to replace the decorative covers and the decorative element being replaced when the first end of all of the plurality of elongated members are rejoined.

4. The hanging plant support of claim 3 further comprising means for keeping the plurality of elongated members separated from each other so that the container is properly supported in the plant support.

5. The hanging plant support of claim 4 further comprising hanger means having a first attachment end and a second attachment end, the first end of each of the plurality of elongated members being attached to the first attachment end to join all the first ends together and the second attachment end being used to hang the hanging plant support from the support surface, the decorative element being placed over the hanger means.

6. The hanging plant support of claim 5 wherein the plurality of elongated members each has a second end, the first and second ends of all of the plurality of elongated members being joined together and attached to the first attachment end of the hanger means to join them all together.

7. The hanging plant support of claim 1 further comprising a decorative element that is placed over the one end of all of the plurality of elongated members after they are joined together, the decorative element being removed to unjoin the first end of all of the plurality of elongated members to replace the decorative covers and being replaced when the first end of all of the plurality of elongated members are rejoined.

8. The hanging plant support of claim 7 further comprising means for keeping the plurality of elongated members separated from each other so that the container is properly supported in the plant support.

9. The hanging plant support of claim 8 further comprising hanger means having a first attachment end and a second attachment end, the first end of each of the plurality of elongated members being attached to the first attachment end to join all the first ends together and the second attachment end being used to hang the hanging plant support from the support surface, the decorative element being placed over the hanger means.

10. The hanging plant support of claim 9 wherein the plurality of elongated members each has a second end, the first end and second end of all of the plurality of elongated members being attached to the first attachment means of the hanger means to join them all together.

11. The hanging plant support of claim 1 further comprising means for keeping the plurality of elongated members separated from each other so that the container is properly supported in the plant support.

12. The hanging plant support of claim 11 further comprising hanger means having a first attachment end and a second attachment end, the first end of each of the plurality of elongated members being attached to the first attachment end to join all the first ends together and the second attachment end being used to hang the hanging plant support from the support surface.

13. The hanging plant support of claim 12 wherein the plurality of elongated members each has a second end, the first end and second end of all of the plurality of elongated members being attached to the first attachment means of the hanger means to join them all together.

14. The hanging plant support of claim 1 further comprising hanger means having a first attachment end and a second attachment means, the first end of each of the plurality of elongated members being attached to the first attachment end to join all the first ends together and the second attachment end being used to hang the hanging plant support from the support surface.

15. The hanging plant support of claim 14 wherein the plurality of elongated members each has a second end, the first and second ends of all of the plurality of elongated members being attached to the first attachment means to join them together.

16. The hanging plant support of claim 1 wherein the plurality of elongated members each has a second end, the first end and second end of all of the plurality of elongated members are joined together.

17. The hanging plant support of claim 1 wherein ones of the first plurality of decorative covers need not all be replaced by ones of the second plurality of decorative covers.

18. The hanging plant support of claim 1 wherein the first end of each of the elongated means is knotted together to join them together.

19. The hanging plant support of claim 1 wherein the elongated members are ropes and the decorative covers are tubular and slide over the ropes.

20. The hanging plant support of claim 1 wherein the elongated members are fastened together under the bottom of the plant container.
